(19) United States
(12) Patent Application Publication
(10) Pub. No.: US 2009/0043661 A1
(43) Pub. Date: Feb. 12, 2009

(54) CLIENT-SERVER SYSTEM FOR MANAGING AN ITEM DATABASE AND ITEM TRANSACTIONS WITH USER-ITEM ASSOCIATIONS

(75) Inventors: James C. Chong, Orinda, CA (US); Robert M. Lee, JR., Oakland, CA (US); Albert C. Loh, Oakland, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Wigix, Inc., Oakland, CA (US)

(21) Appl. No.: 12/188,100

(22) Filed: Aug. 7, 2008

Related U.S. Application Data
(60) Provisional application No. 60/954,716, filed on Aug. 8, 2007.

(51) Int. Cl. G06Q 30/00; G06Q 10/00; G06F 17/30

(52) U.S. Cl. 705/14; 705/30

(57) ABSTRACT

A computer system is provided that maintains information about products and provides for transactions between users buying/selling those products as well as providing a public exchange for users wishing to value those products or obtain more information about those products. The system also tracks the users who set up products in the system as well as maintain product categories. That tracking can be used for sharing revenue related to those products with the users, controlling which users become “experts” for a category of products or specific products, allow for user-to-user interactions, etc.

This application claims priority to U.S. Provisional Application No. 60/954,716 entitled “Client-Server System For Managing an Item Database and Item Transactions with User-Item Associations” filed on Aug. 8, 2007, which is hereby incorporated in its entirety.

### FIELD OF THE INVENTION

The present invention relates to an online item and product management system associated with a related transaction processing system. In particular, the present invention relates to a product management system wherein users can provide information about items and users are associated with items and categories.

### BACKGROUND OF THE INVENTION

The Internet has provided some amazing opportunities to connect people and provide information. However, sometimes is it difficult to obtain all of the information people need, especially where the domain of the information is quite large. For example, where the domain is products, there are a great many products that users might be interested in. Additionally, different users may be searching for different pieces of information about a product. For example, some users may want to buy or sell a product, while other user may want to value products they already have. Yet other users may simply wish to learn more about a product.

Many resources on the Internet can help solve aspects of this problem. For example, search engines can be used to find web pages with relevant content. Discussion boards, newsgroups, and blogs on the Internet can also be used to find information. However, all of these sources of information can at times be incomplete, untrustworthy, or difficult to find for one reason or another.

It would be desirable to have a centralized location where information on a variety of products could be easily found and where those products can be easily exchanged between users of this centralized community. Additionally, it would be desirable to have a mechanism to give incentives to users to not only use the community to obtain information, but also to contribute complete and accurate information to the community.

### BRIEF SUMMARY OF THE INVENTION

In an embodiment of the present invention, a computer system is provided that maintains information about products and provides for transactions between users buying and selling those products as well as providing a public exchange for valuing those products. The system also tracks the users who set up products in the system as well as maintain product categories. That tracking can be used for sharing revenue related to those products with the users, controlling which users become “experts” for a category of products or specific products, allowing for user-to-user interactions, etc.

One embodiment of an apparatus for tracking user contributions and distributing revenue associated with the user contributions is comprised of an item database, an item server coupled to the item database, a transaction database, and a transaction server coupled to the transaction database. The item server is capable of reading and modifying the item database, and the transaction server is capable of reading and modifying the transaction database. The item database comprises a table of associations. The table of associations associates an owner with an item record. An owner is a user that contributed to the item database by requesting the item record to be added to the item database or by perfecting an existing item record. The transaction database comprises a table of transactions that associates revenue with item records.

Another embodiment for distributing revenue associated with user contributions to a community of users begins by registering a user with a community of users. Next, the user is associated with a referral chain if the user was referred to the community of users by a referral user. A referral chain associates the user with a chain of users who have each referred each other to the community of users. Following the referral chain association, one or more pages are assigned to the user. Revenue from the community of users is then associated with one or more pages. Finally, at least a portion of the revenue associated with one or more pages is shared with the user assigned to the page and with up to N additional users in the referral chain of the user.

### BRIEF DESCRIPTION OF THE DRAWINGS

FIG. 1 is an illustration of a computer system suitable for use with the present invention.

FIG. 2 is a simplified block diagram of a computer system that may incorporate embodiments of the present invention.

FIG. 3 is a schematic diagram of a network over which an embodiment of the present invention may be used.

FIG. 4 is a simplified block diagram illustrating one process which an embodiment of the present invention may use to create users and allow those users to become SKU owners.

FIG. 5 is an illustration of a form which an embodiment of the present invention may use.

FIG. 6 is a simplified block diagram of an item database structure which an embodiment of the present invention may use.

FIG. 7 is a diagram illustrating a referral relationship that an embodiment of the present invention may use.

FIG. 8 is a diagram illustrating a referral relationship which an embodiment of the present invention may use.

FIG. 9 is a diagram illustrating a referral tree which an embodiment of the present invention may use.

FIG. 10a is a simplified block diagram of a referral database structure which an embodiment of the present invention may use.

FIG. 10b is a diagram showing how one embodiment represents the data underlying revenue and payouts.

FIG. 11 is a diagram illustrating revenue sharing engine and payout system design structure which an embodiment of the present invention may use.

FIG. 12a is a diagram illustrating revenue sharing and payout flow which an embodiment of the present invention may use.

FIG. 12b is a diagram illustrating revenue sharing and payout flow which an embodiment of the present invention may use.

FIG. 13 is a simplified block diagram illustrating of a data model for revenue sharing and payout which an embodiment of the present invention may use.

FIG. 14 is a diagram illustrating one embodiment of the present invention.

### DETAILED DESCRIPTION OF THE INVENTION

An improved product management, transaction and presentation system is described herein.

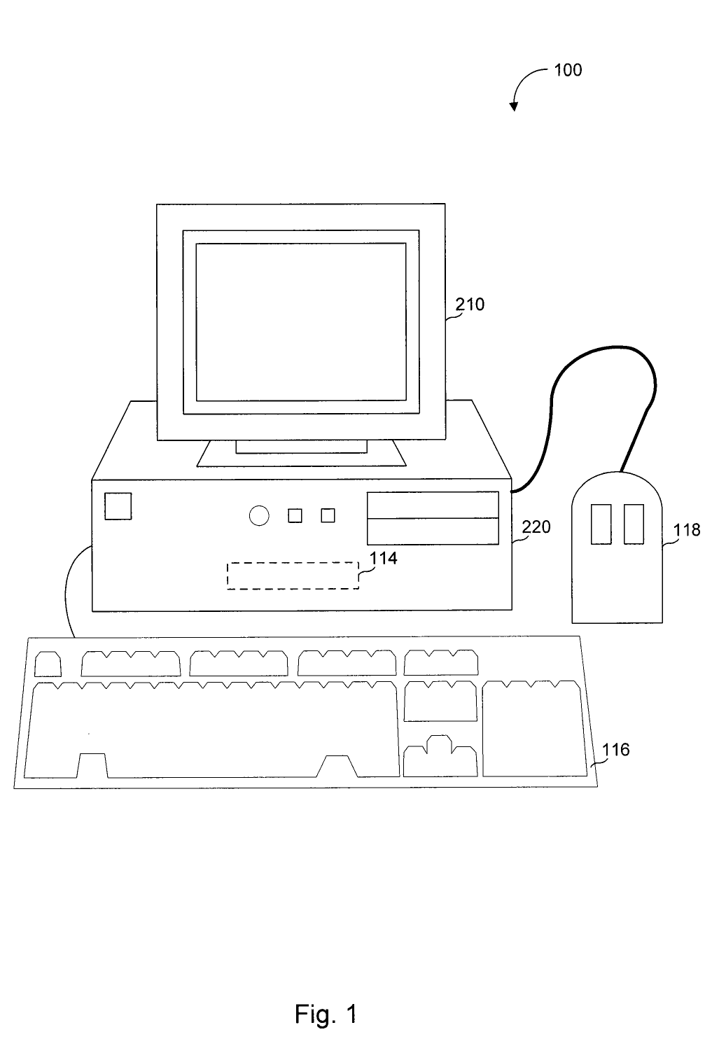

FIG. 1 is an illustration of a computer system 100 suitable for use with the present invention. The computer system 100 can include components such as a computer 220, storage devices such as a hard drive 114, input devices such as a keyboard 116 and mouse 118, and output devices such as a monitor 210. One skilled in the art will recognize that there are possibly many other components of a computer system 100 that are not illustrated in FIG. 1. For example, a typical computer system 100 will often include one or more processors, random access memory, various buses, network interfaces, and other components.

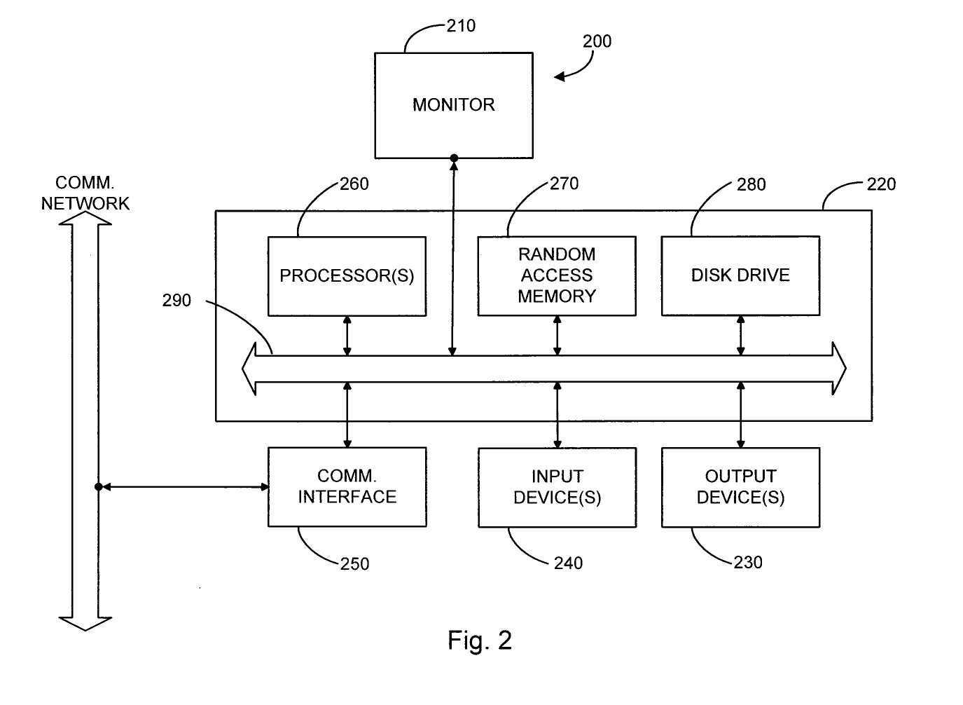

FIG. 2 is a simplified block diagram of a computer system 200 that may incorporate embodiments of the present invention. FIG. 2 is merely illustrative of an embodiment incorporating the present invention and does not limit the scope of the invention as recited in the claims. One of ordinary skill in the art would recognize other variations, modifications, and alternatives.

In one embodiment, computer system 200 typically includes a monitor 210, a computer 220, user output devices 230, user input devices 240, communications interface 250, and the like.

As shown in FIG. 2, computer 220 may include a processor(s) 260 that communicates with a number of peripheral devices via a bus subsystem 290. These peripheral devices may include user output devices 230, user input devices 240, communications interface 250, and a storage subsystem, such as random access memory (RAM) 270 and disk drive 280.

User input devices 230 can include various possible types of devices and mechanisms for inputting information to a computer 220. These may include a keyboard, a keypad, a touch screen incorporated into the display, audio input devices such as voice recognition systems, microphones, and other types of input devices. In various embodiments, user input devices 230 are typically embodied as a computer mouse, a trackball, a track pad, a joystick, wireless remote, drawing tablet, voice command system, eye tracking system, and the like. User input devices 230 typically allow a user to select objects, icons, text and the like that appear on the monitor 210 via a command such as a click of a button or the like.

User output devices 240 can include various possible types of devices and mechanisms for outputting information from computer 220. These may include a display (e.g., monitor 210), non-visual displays such as audio output devices, etc.

Communications interface 250 provides an interface to other communication networks and devices. Communications interface 250 may serve as an interface for receiving data from and transmitting data to other systems. Embodiments of communications interface 250 typically include an Ethernet card, a modem (telephone, satellite, cable, ISDN), (asynchronous) digital subscriber line (DSL) unit, FireWire interface, USB interface, and the like. For example, communications interface 250 may be coupled to a computer network, to a FireWire bus, or the like. In other embodiments, communications interfaces 250 may be physically integrated on the motherboard of computer 220, and may be a software program, such as soft DSL, or the like.

In various embodiments, computer system 200 may also include software that enables communications over a network such as the HTTP, TCP/IP, RTP/RTSP protocols, and the like. In alternative embodiments of the present invention, other communications software and transfer protocols may also be used, for example IPX, UDP or the like.

In some embodiment, computer 220 includes one or more Xeon microprocessors from Intel as processor(s) 260. Further, one embodiment, computer 220 includes a UNIX-based operating system.

RAM 270 and disk drive 280 are examples of tangible media configured to store data such as embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like. RAM 270 and disk drive 280 may be configured to store the basic programming and data constructs that provide the functionality of the present invention.

Software code modules and instructions that provide the functionality of the present invention may be stored in RAM 270 and disk drive 280. These software modules may be executed by processor(s) 260. RAM 270 and disk drive 280 may also provide a repository for storing data used in accordance with the present invention.

RAM 270 and disk drive 280 may include a number of memories including a main random access memory (RAM) for storage of instructions and data during program execution and a read only memory (ROM) in which fixed instructions are stored. RAM 270 and disk drive 280 may include a file storage subsystem providing persistent (non-volatile) storage for program and data files. RAM 270 and disk drive 280 may also include removable storage systems, such as removable flash memory.

Bus subsystem 290 provides a mechanism for letting the various components and subsystems of computer 220 communicate with each other as intended. Although bus subsystem 290 is shown schematically as a single bus, alternative embodiments of the bus subsystem may utilize multiple busses.

FIG. 2 is representative of a computer system capable of embodying the present invention. It will be readily apparent to one of ordinary skill in the art that many other hardware and software configurations are suitable for use with the present invention. For example, the computer may be a desktop, portable, rack-mounted or tablet configuration. Additionally, the computer may be a series of networked computers. Further, the use of other micro processors are contemplated, such as Pentium™ or Itanium™ microprocessors; Opteron™ or AthlonXP™ microprocessors from Advanced Micro Devices, Inc; and the like. Further, other types of operating systems are contemplated, such as Windows, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board.

The specification and drawings are, accordingly, to be regarded in an illustrative rather than a restrictive sense. It will, however, be evident that various modifications and changes may be made thereunto without departing from the broader spirit and scope of the invention as set forth in the claims. In addition, the technique and system of the present invention is suitable for use with a wide variety of methodologies for programming a device. The scope of the invention should, therefore, be determined not with reference to the above description, but instead should be determined with reference to the pending claims along with their full scope or equivalents.

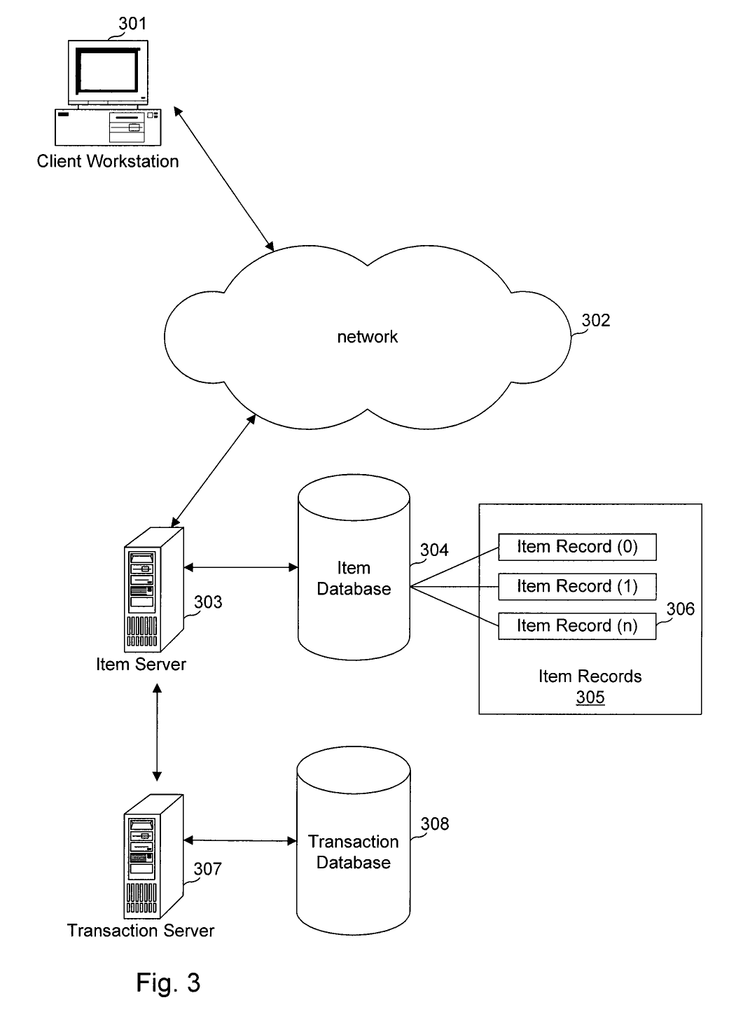

FIG. 3 is a schematic diagram of a network over which an embodiment of the present invention may be used. A user may use client workstation 301 to communicate with item server 303 through network 302. In one embodiment, the network 302 is the Internet. Item server 303 is coupled to item database 304 and is capable of reading, writing and modifying item database 304.

Item database 304 contains a table of item records 305. Item records can further be organized into categories in the item database. Item record 306 represents one item record or one page from item records 305. Each item record in item database 304 is associated with a SKU (Stock Keeping Unit) number. As used herein, the “term item record” and “SKU” are interchangeable. The term “SKU” may also be used for the item the SKU refers to. Often times, the item the SKU refers to is presented to the user, along with other information, in the form of a web page or other similar presentation means. The term “page” is often used in place of the term “SKU” from an end-user's perspective, and the terms have the same definition as used herein.

At a high level, each SKU within item database 304 is homesteaded by a user of the invention. When a SKU is homesteaded by a user, the SKU is claimed by the user, and an ownership interest in the SKU is given to the user. As used herein, the terms homesteaded, claimed, owned, or variants thereof all refer to this concept. A SKU owned by the user can be referred to as a homesteaded item. When a user homesteads a SKU, the user gains the potential for earning revenue off of that SKU. There are many different ways that a user can gain an ownership interest in a SKU. There are also many different ways that a SKU can generate revenue. Additionally, the means used to determine the how revenue is shared between users with an interest in a SKU can vary between embodiments. All of these variations are discussed in more detail below.

FIG. 3 also shows a transaction server 307 that can be used to process transactions related to SKUs. The transaction server 307 has a connection with the item server 303 and the transaction server 307 is coupled to a transaction database 308. In one embodiment, the transaction database 308 can maintain a table of transactions that associates revenue with SKUs. In one embodiment, when a revenue-generating transaction related to SKU passes through the transaction server 307, the transaction server 307 can query the item server 303 to find the owner of the SKU in the transaction. A portion of the transaction revenue may then be shared with the SKU owner.

Another method for a user to acquire an financial interest is to become a category expert. A category expert is much like a securities analyst in the stock market or a subject matter expert in the technology world. The category experts may write reports on the categories they cover to provide analysis and guidance to help users make informed decisions whether to buy, sell, or hold some specific items. The report may contain a product review, valuation opinion, and/or answers to questions posted by users. A portion of the category revenue may be allocated to the experts for sharing knowledge, driving traffic, and/or raising the performance of a category that satisfies the needs of the community.

Other users who don't own a particular SKU can add it to their user profiles in item database 304. Although these users don't own the item record in the item record database, they may physically own the item at their home, workplace, etc. By adding items to user profiles, the user can use item server 303 as an online inventory system or an asset management tool for organizing and recording details of personal belongings and tracking the associated monetary value. It can also be a marketplace for buying and selling goods, thereby creating liquidity for non-financial assets, for example, watches and cell phones.

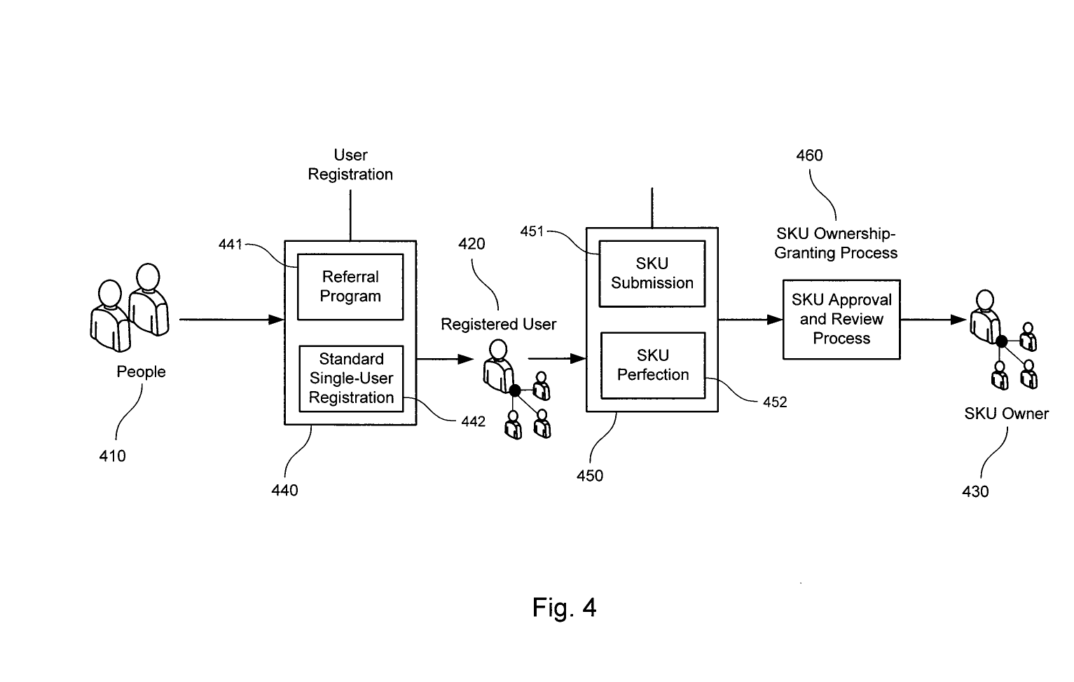

FIG. 4 is a simplified block diagram illustrating one process which an embodiment of the present invention may use to create users and allow those users to become SKU owners.

The process begins when users, represented by people 410, register with the community. This registration process can take place using a client workstation 301 connected to a registration server or the process can take place using any other suitable means.

At step 440, the user registration process determines whether the user is registering using a standard single-user registration 442 or through a referral program 441. Single-user registration 442 is one means through which a user can join the community. During this process, the user discloses some basic information about themselves, such as contact information, along with other pieces of information. Once the single-user registration is complete, the newly created user is ready to participate in the community.

Another means for joining the community is through the referral program 442. When a new user joins the community as a result of a referral made by an existing user of the community, a referral chain between the users is created. In one embodiment, when the new user becomes a homesteader and the associated homesteaded item generates revenue, not only does the homesteader receive a portion of the revenue generated, but the existing user who referred the homesteader into the community receives a portion of the revenue generated from the new user's homesteaded item. A referral chain can be used to define this relationship between users. Users who qualify for financial incentive through the referral chain are called “stakeholders”. As used herein, a stakeholder can also be called a referrer or a sponsor. The new user who was referred into the system can also be called a referred user, a recruited user or recruit, or a sponsored user.

After the user registration 440 is complete, the user becomes a registered user 420. As a registered user 420, the user can now participate in the community by acquiring SKUs, becoming a category expert, conducting transactions in the community, or participating in the community in other ways.

A user can acquire a SKU ownership interest, and thus a financial interest, in a SKU in a variety of ways. One such way is for a user to add an item that is not currently listed in item database 304. This is shown as SKU submission 451. Another way is for a user to correct, improve, enhance or otherwise perfect an existing item, thereby laying claim to it. This is shown as SKU perfection 452. Other ways for a user to obtain a SKU ownership interest can also be implemented in step 450. For example, in some embodiments a user can acquire a SKU ownership interest by trading for the interest from another user.

SKU submission 451 may begin by the user entering a series of required product attributes into a form. The user may also be required to submit a picture of the item referred to by the SKU. Once the user has finished entering these attributes, item server 303 may attempt to locate an existing SKU with similar attributes, to see if the submitting SKU might already exist. If it finds some potential matches, the matches can be presented to the user and the user can be prompted to verify that the SKU should still be submitted. If the user indicates that the SKU should still be submitted, or if the system finds no matches, then the item server may display a page preview and/or confirmation page.

Another way in which a user can claim ownership of a SKU is by “perfecting” an existing SKU in item database 304. This step is shown at step 452. At any given time there can be a number of existing SKUs within item database 304 with incomplete or missing information, and these SKUs can be marked as requiring “perfecting”. For this purpose, item database 304 tracks which items are candidates for perfection. A user can search through the catalog looking for SKUs requiring perfecting. The user may then supply the missing or incorrect information.

In one embodiment, after the user confirms the information entered during the SKU submission 451 or SKU perfection 452 process, the SKU may be placed into a “pending” table for review and approval/rejection. This pending table may be periodically reviewed by a category expert, catalog administrator, other reviewing entity who can review that submission and either approve or reject it. This step is shown at step 460. If approved, the user can be notified, and at that point the user will officially own the SKU and can start deriving future revenue from it. It is at this point the user becomes a homesteader for that particular item. If the submission is rejected, then the user may or may not receive an opportunity to resubmit the SKU depending on the quality of the initial submission.

Once a user becomes a SKU Owner 430, that SKU and its revenue generating activity (including, but not limited to, transactional and advertising revenue) can be closely tracked and associated with that user in order to provide accurate accounting and revenue payout. In one embodiment, the relationship between a SKU Owner and a SKU can be stored in the Item Database 304 in a table of associations.

In some embodiments, once a user becomes a SKU Owner 430, the user can sell, trade, or otherwise transfer their ownership interest in the SKU to another user. The ownership interest can thus become a tradable commodity in the community that can be valued based at least in part on the current or future revenue that the SKU is able to generate for the owner of the SKU. Some embodiments may even setup a marketplace or exchange to facilitate transactions involving the SKU ownership interests.

A user can be a homesteader, a stakeholder, and a category expert all at the same time, and as a result, there are many different incentives given to a user to become an active, productive, participating member of the community.

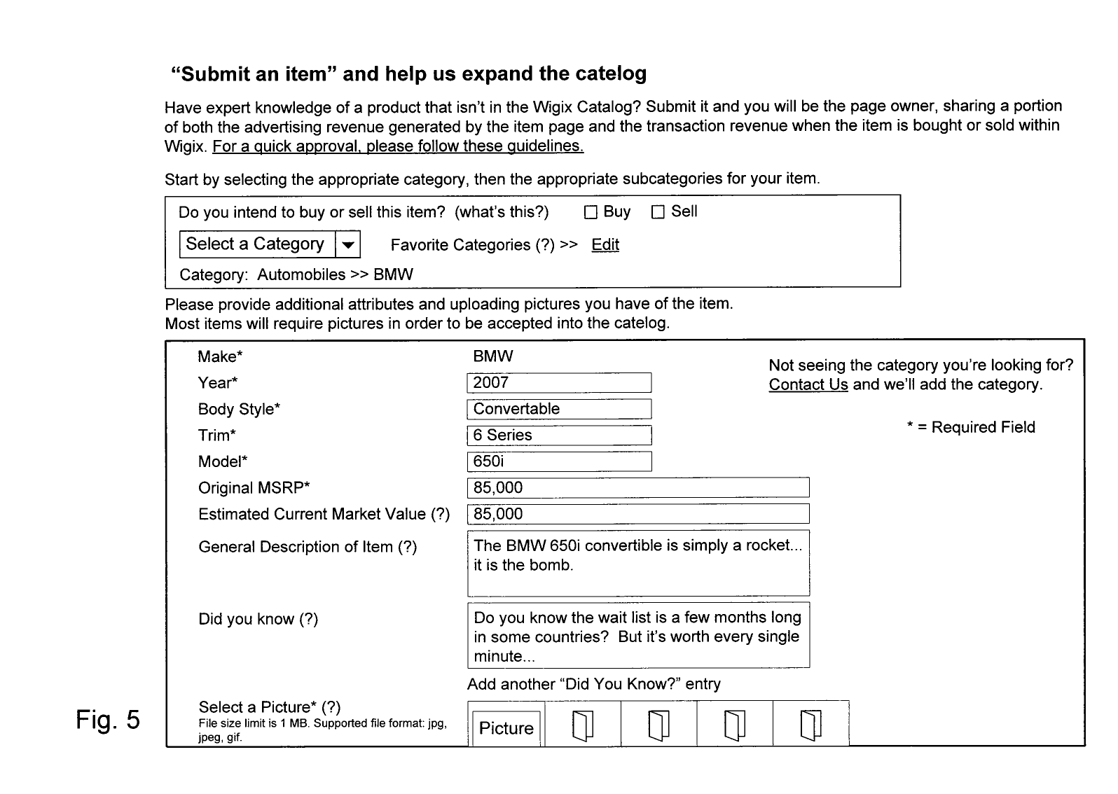

FIG. 5 is an illustration of a form which an embodiment of the present invention may use. Client workstation 301 may display a form similar to the one in FIG. 5. The form shows one example of how a registered user may enter information to create or perfect a SKU.

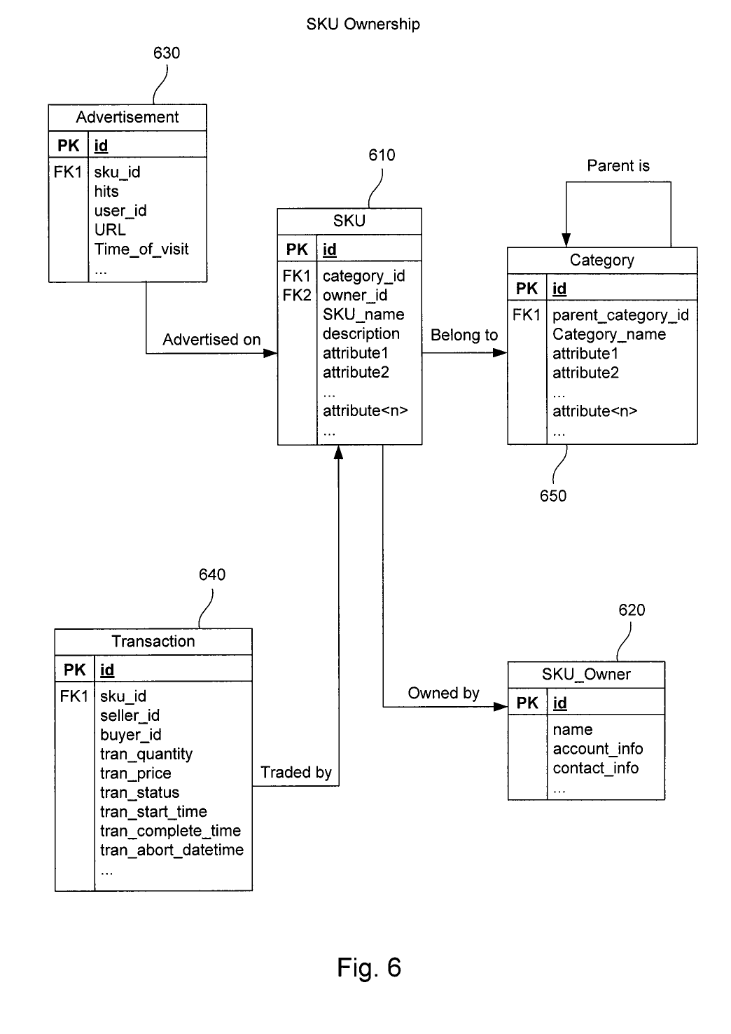

FIG. 6 is a simplified block diagram of an item database structure which an embodiment of the present invention may use. The database structure tracks information related to SKUs as well as sets up relationships between SKUs and other aspects of the invention. For example, SKUs can be related to SKU owners, category information, and revenue information. The database structure may reside completely or partially in the item database 304, transaction database 308, or in any other suitable repositories.

Block 610 represents the SKU itself. Each SKU entry contains a list of attributes that describe the SKU in detail. For example, information about the manufacturer, model number or name, color, price, etc., of the SKU may be stored.

Additionally, each SKU entry contains information that links the SKU to a variety of other pieces of information. For example, the SKU can contain a reference linking the SKU to the SKUOwner 620. Advertising 630 and transaction 640 tables can also link to the SKU so that revenue generated by this SKU can be uniquely tracked. SKUs may also belong to a category 650 and these categories may be subordinate to one or more “parent” categories as well. This category information can be stored in a category table. The category table may be stored in the item database 304 or in another database. The branch within the category tree which a SKU belongs to may determine the specific attributes that are required for that SKU. The category may also have one or more category experts associated with the category.

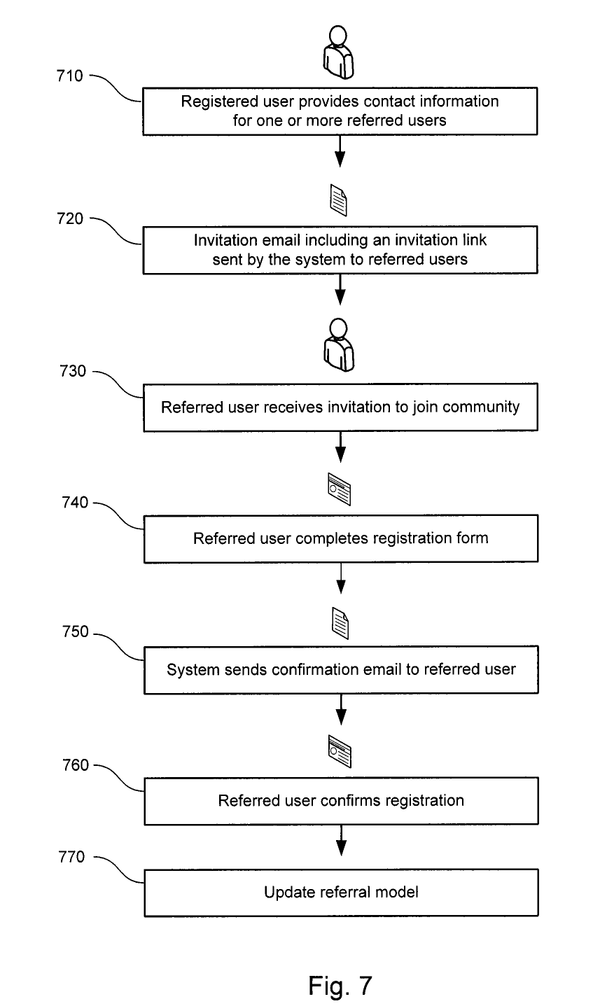

FIG. 7 is a diagram illustrating a referral relationship that an embodiment of the present invention may use. The referral process may begin when a registered user provides the names and e-mail addresses of family, friends, and colleagues. This step is shown at 710.

At step 720 the transaction server 307 may send an introductory e-mail inviting these referrals to join as registered members of transaction server 307. In other embodiments, other components of the system may send the invitation email.

At step 730, the referred user receives the invitation. This invitation will often introduce the referred user to the community, explain some of the benefits of joining the community, and also contain a reference to the registered user who referred the referred user to the community.

The referred user can complete a registration form at step 740. To qualify for financial incentive, the referred user may need to provide their social security number, mailing address, date of birth, and an active credit card and/or bank account for identification purpose. The referrer may be responsible for ensuring his immediate downline referrals provide such information to qualify for financial incentive. Otherwise, the referrer himself/herself may be disqualified from receiving a payout too. If such requisite information is not provided, payment due to a delinquent stakeholder or homesteader for that particular payment cycle may be skipped and moved upline to the next qualifying referrer.

As an example, assume that A refers B, B refers C, and C refers D, and all of them have provided the requisite information except D. In this case, if there is a payout due to D, only B and A will receive his or her portion of the income. C is disqualified from receiving an income for failing to ensure that D provide the requisite information. If a referral becomes a homesteader, transaction server 307 may assign an identifier, identifying this registered member as a homesteader who may be eligible for a share of the transaction and advertisement revenues. Eligibility may depend on whether the homesteader provides the requisite information to qualify for financial incentive. In summary, transaction server 307 can verify the following information before a cash disbursement is made payable to a registered member.

Once the referred user complete the registration form and is sent to the system, some embodiments may send a follow-up confirmation email as shown in step 750. This email is often used to validate the new user before they join the community.

After a prospective new user confirms his registration in step 750, the relationship between the newly registered member and the user who referred the new member can be established. This is shown in step 760. The transaction database 308 may assign an identifier to the referrer, identifying him/her as a stakeholder for the immediate and subsequent referral relationships. Likewise, transaction server 307 may assign a unique identifier to each referred registered member, identifying and associating him/her to a particular referral level or layer within the tiered compensation scheme.

In one embodiment, the financial relationship between users terminates once a user is more than three layers removed from another user in the referral chain. For example, if A is the first referrer and his referral chain consists of A>B>C>D>E>F>G, A will have no financial relationship with E, F and G because the chain ends at the 3rd downline layer.

If there is a limit on how deep a referral chain for a particular user can reach, the referral model may need to be updated accordingly at step 760. For example, if the referral limit is 3 levels deep and the referral structure grows beyond that limit, the top level referrers may be eliminated progressively 1 level at a time so that at all times, the referral structure will consistently not have more than 3 levels of referral memberships. By the same token, a referred registered member can also be a referrer.

Once the referral model is updated, the updated relationships between users can be stored in a referral model for future use.

The referral model, which stores referral tree that maps referrers to referees, can be generated and maintained by transaction server 307. Some assumptions regarding the structure and functionality of the referral tree may exist in various embodiments of the system. For example, it may be assumed that no circular referral relationship exists between sponsor and recruit, and that a recruit has one and only one direct sponsor. In other embodiments, a user could have more than one sponsor, including a direct one and indirect ones. Other possible assumptions are: users map to nodes in one tree wherein the root node is assigned to the system operator, users' IDs on the tree are positive integers with a root id equal to 0, and updates on tree happens in real time and concurrently.

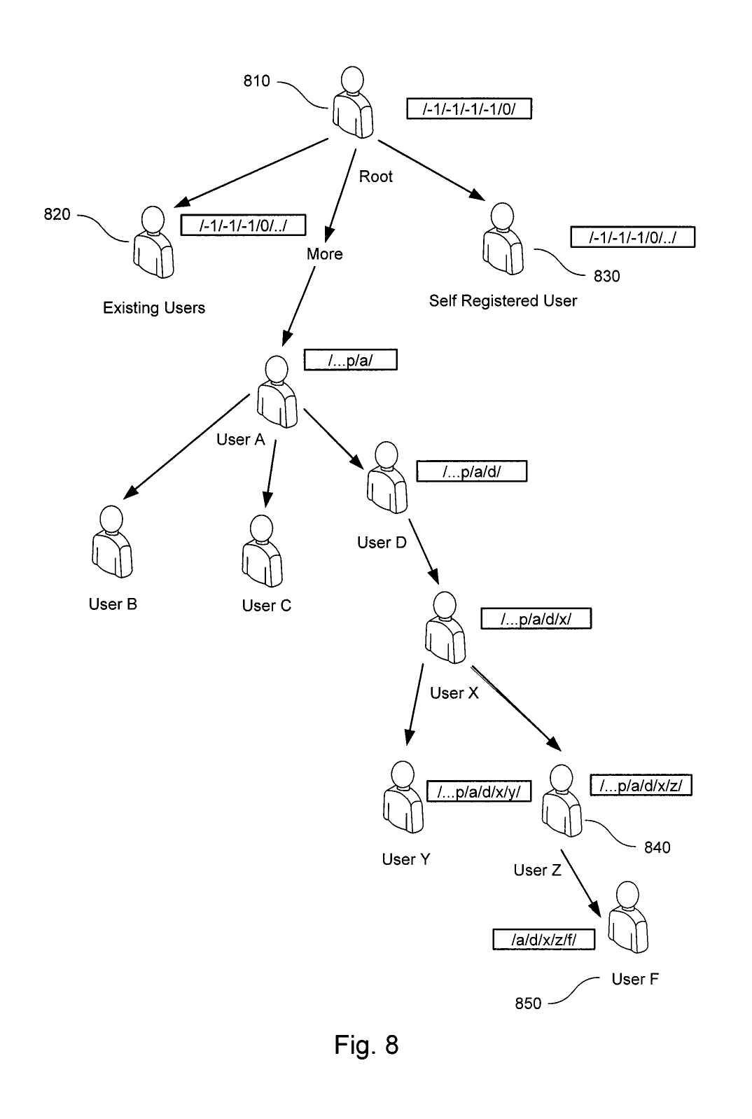

FIG. 8 is a diagram illustrating a referral tree which an embodiment of the present invention may use. Many different operations may be supported by the referral tree. For example, the tree can be initialized or rebuilt using the referral relationships stored in the referral model. Users can be added to the referral tree. Users can also be deleted from the referral tree and any recruits of the deleted user can be reassigned to the recruiter of the deleted user. Groups of users can have their referral relationships reassigned. Relationships between nodes, such as whether the nodes are sibling nodes, referrer/referee nodes, or other relationships can be determined. The distance between nodes on the tree can also be computed. Additional operations on the referral tree can also be implemented depending on the needs of a particular embodiment.

In the example referral tree shown in FIG. 8, the root node is labeled “Root” and has an ID equal to 0. This is shown at 810. Registered users may be nodes of the tree with a positive integer ID. Every branch of tree may represent a referral relationship from sponsor to recruit. For those users already registered 820 and the future self-registered user 830, their sponsor is assigned to ‘root’. In one embodiment, each node may remember up to N upper levels of nodes in its record. As a result, it becomes computationally cheap to query a node's sponsors or add a user as leaf to a node. For the operations of querying less-than-N-level recruits of a user or deleting that user, only a small part of the tree (N levels below the user) needs to be updated in about N SQL statements. Each node in FIG. 8 maintains a field ‘sponsor_id’ and a field ‘sponsor_hierarchy’ which is a string in format ‘/<Nth level ancestor id>/ . . . /<sponsor id>/<node id>/’, where if sponsors are less than N, use −1 in the ‘/ . . . /’ segment. N is a pre-defined parameter for the maximum levels of sponsors that a node can ‘remember’. The sample referral tree in FIG. 8 has set N equal to 5. For user Z 840, the sponsor_hierarchy is ‘/p/a/d/x/z/’ and his recruit F 850 is ‘/a/d/x/z/’. For the first level user in the tree, the sponsor_hierarchy is a string like ‘/−1/−1/−1/−0/ . . . /’.

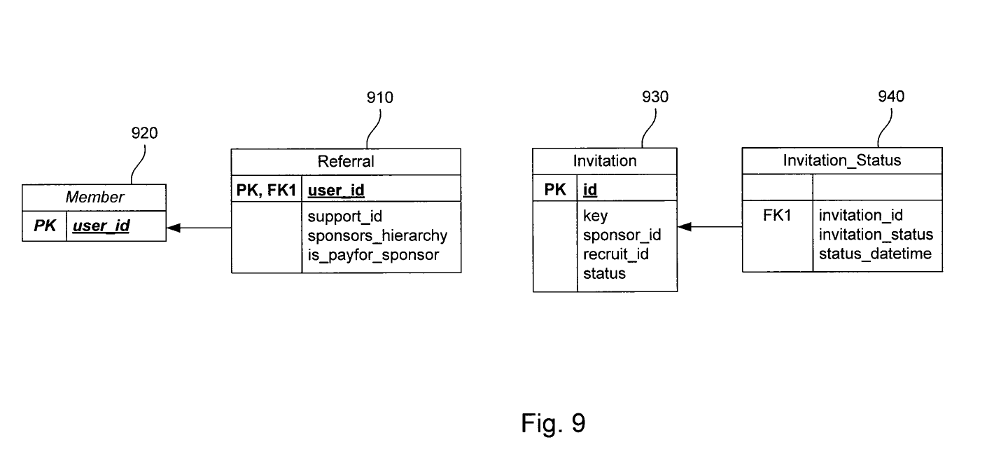

FIG. 9 is a simplified block diagram of a referral database structure which an embodiment of the present invention may use. The referral table 910 can be added to the item database 304 as shown in the data model diagram in FIG. 9. Alternatively, the referral table can reside in another database. The referral table 910 contains a number of user records with information similar to what was graphically displayed in FIG. 8. The user records in the referral table 910 can link to additional user tables, such as table 920. In some embodiments, the referral database structure may also contain tables storing the invitations created from user referrals and the status of those invitations. Example tables 930 and 940 show one embodiment of data structure.

The performance is determined by parameter N and SQL execution speed. For the speed of SQL statements, all operations listed above depend on database performance for statements with condition LIKE ‘<prefix>%’ where <prefix>does not contain ‘%’. Most relational databases can execute this kind of SQL statement efficiently with an index built on that field. If the database is a MySQL database, it can run fast with low cost. It is possible to return a query in 1,000,000 record table in only 2 ms. Pseudocode representing processes that a computer system might execute to implement the methods described herein are listed in Appendix A. An analysis conclusion for how many SQL executions are needed in the operations follows below.

Using a data structure such as the one presented in this example embodiment, various operations on the referral tree require a different number of SQL executions to be run against the database.

For example, some operations, including adding a single user or finding the sibling of a user, only need 1 or 2 SQL executions to complete the operation no matter what the size of N is.

Other operations, including deleting a user without deleting the user's recruits and adding a referral sub-tree to the referral tree, require approximately N SQL executions to complete the operation.

Still other operations, including querying or counting the sponsors of a user, determining if two nodes have a referrer/referee relationship, determining the distance between two nodes, or determining the distance from the top node to a lower node in the referral tree, require N SQL executions. Normally, if the number of queried levels is less than N, the operation can be done with a single SQL statement. Even if the number of queried levels is greater than N, fewer than N SQL statements can be used if the example data structure is leveraged properly.

For some other operations, including querying or counting the recruits of a user, the number of queries required depends on shape of tree. Normally, if N is greater than the queried levels, the number of SQL executions required will be less than N.

The most expensive operations are typically deleting a single user with his recruits and initializing/reinitializing the entire tree. However, these operations are rarely needed in practice and can often be executed at times when the system does not have a high load.

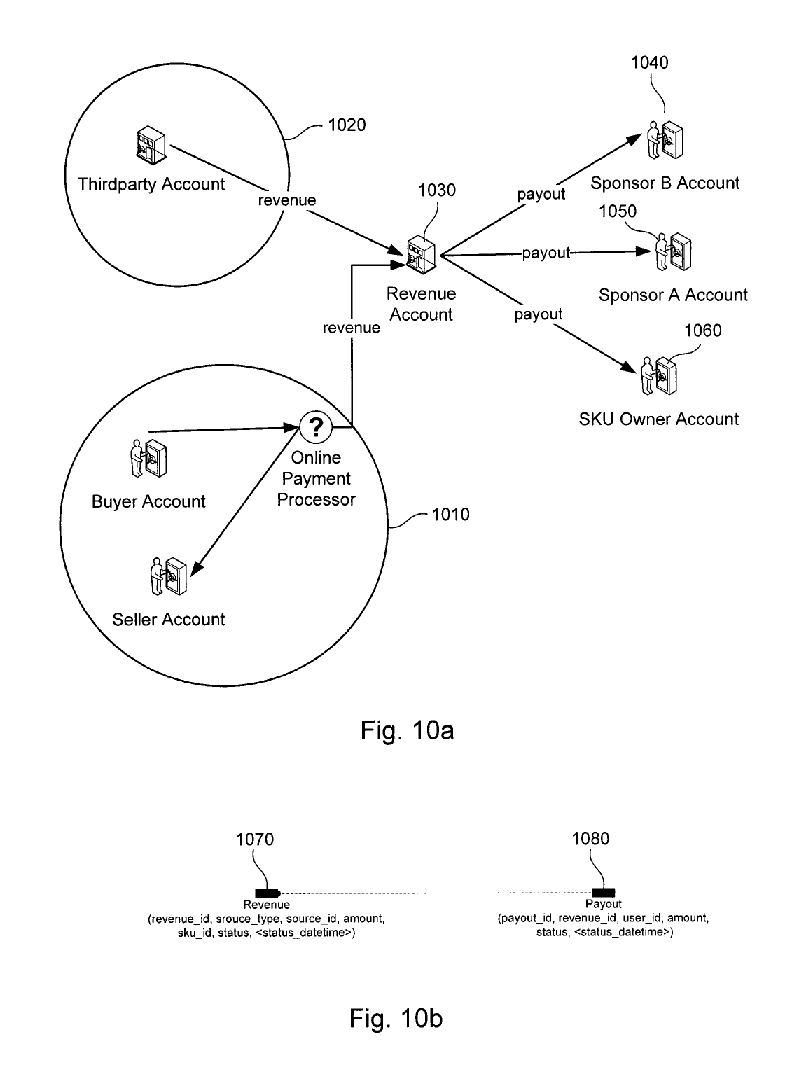

FIG. 10a is a diagram illustrating a revenue sharing engine and payout system design structure that an embodiment may use. Revenue in the illustration typically comes from one of two sources: buying/selling transactions between users involving a SKU, highlighted by 1010, and advertising revenue received from third-party accounts, highlighted by 1020. This revenue can be collected in a central location, such as a revenue account 1030. The revenue sharing engine, which can be a part of the revenue account 1030, can then analyze the collected revenue and distribute payouts to sponsors 1040 and 1050 or SKU owners 1060. The logic used by the revenue sharing engine to distribute the money can use the relationships described above according to the methods disclosed below.

FIG. 10b shows how one embodiment might represent the data underlying revenue 1070 as it enters the system and the corresponding payout 1080 as the revenue is distributed to users.

Assumptions regarding the revenue sharing and payout flow may exist and can be reflected in the data structure. Such assumption can include, but are not limited to, assumptions about where the fee comes from and how the fee is identified. For example, revenue might accrue from fees collected from buyers for a transaction, fees collected from sellers for a transaction, or fees paid by advertisers. Some source information might be used to match revenue to particular SKUs. For example, when payment occurs via an online payment system, such as “PayPal”, the payment may include a payer identifier and a transaction identifier. The transaction identifier may directly specify a SKU, and if so, this information can be used to help allocate the revenue to the proper parties. If the SKU cannot be directly identified, then other heuristics might be used to properly handle the revenue.

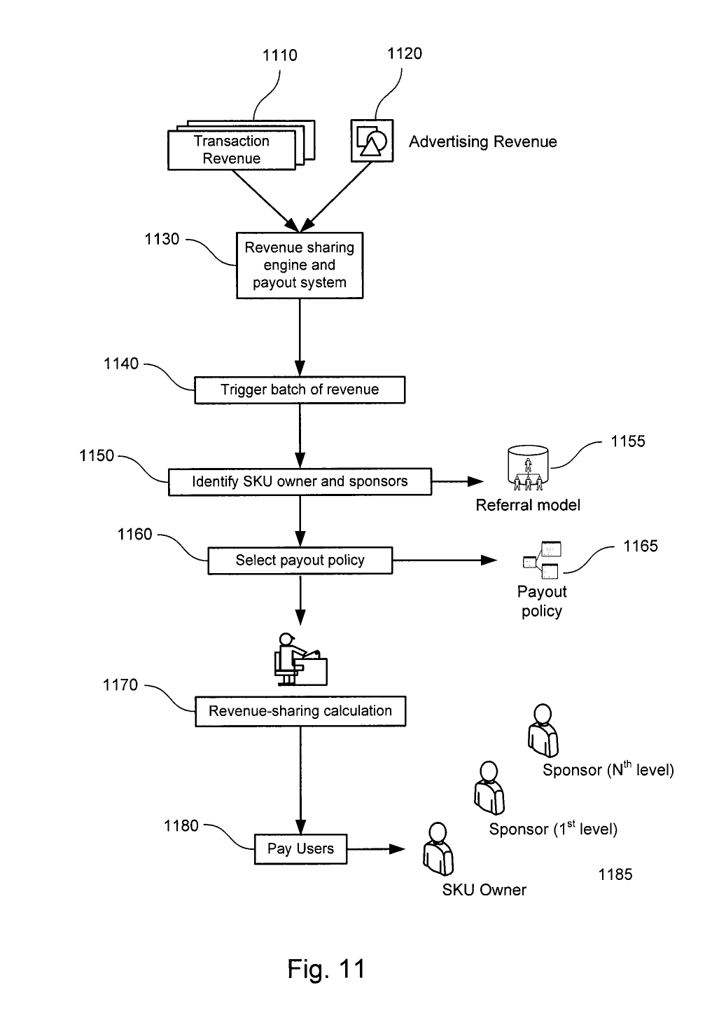

FIG. 11 is a diagram illustrating revenue sharing and payout flow in an embodiment of the present invention.

Initially at step 1130, revenue is entered into a revenue sharing and payout system. In one embodiment, the transaction server 307 can be the device receiving this revenue information. The information entered into the system will generally include data such as the value of the revenue received, SKU identifiers, and other relevant information. Revenue associated with a transaction 1110 will generally have a SKU identified from data in the transaction. Typically the SKU is the item of transaction. Revenue from an advertisement 1120 can be divided to each related SKU according to clicks received from that SKU over some period of time. Other mechanisms can also be used to associate SKU's with received revenue. The revenue's status will generally be set to ‘New’ when it is entered into the system.

Revenue calculations can be done in daily batches, weekly, or monthly, i.e. the revenue-sharing engine is triggered to start its calculation daily, weekly, or monthly. This is shown at step 1140. As a result of the batching process, there might be some time delay between the time when a transaction happens and the money associated with the transaction goes into the user's account. One skilled in the art will recognize that other mechanisms can determine the timing of revenue payouts.

Once a revenue calculation is triggered, the first step of the calculation generally identifies the SKU owner and the owner's N-level sponsors for a given piece of revenue. This is shown at step 1150. As described earlier, the relationships between a SKU owner and any sponsors can be determined from a referral tree that is stored in the referral model 1155.

Once the SKU owner and the owner's sponsors have been identified, an appropriate payout policy 1165 is selected at step 1160. Payout policies determine what percentage of the revenue a user can receive based on the user's relationship to the SKU and the SKU owner. Payout policies can also determine if an otherwise eligible user is to be excluded from receiving a payout. Example payout policies are disclosed in more detail below.

After the payout policy has been selected, the revenue each identified SKU owner and sponsor is entitled to receive is calculated at step 1170. After the calculation, the status of revenue can change to ‘calculated’.

In one embodiment, the revenue is then divided to users in the form of payout record whose status is marked as ‘ready’ according to the payout policy. Finally, the payout can be added to user's balance, and payout status can be changed to ‘balanced’. These actions are shown at step 1180.

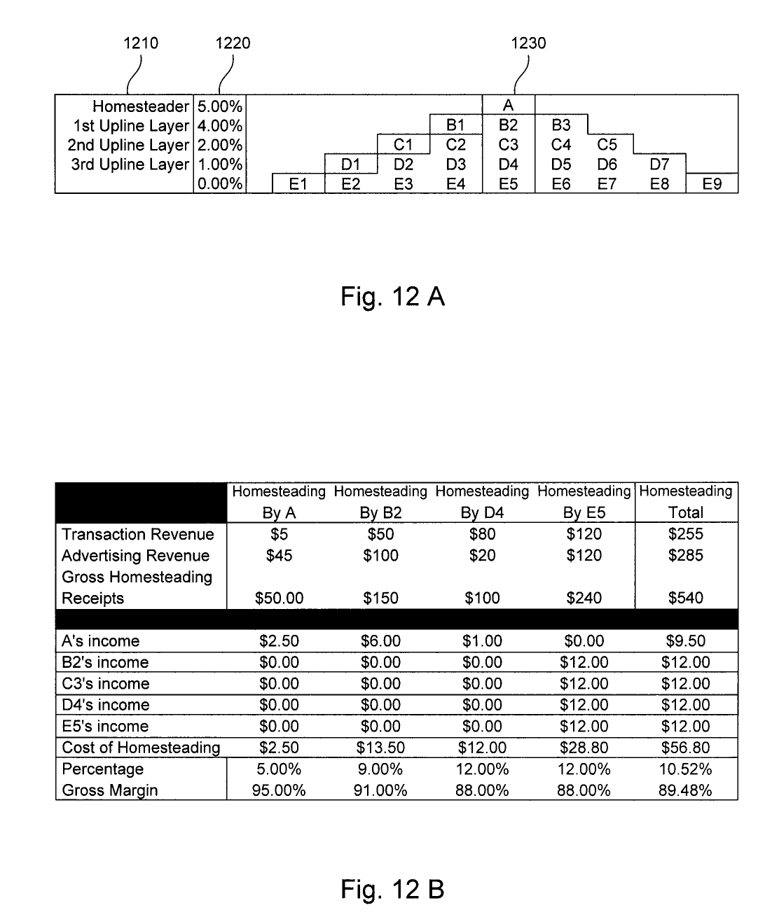

FIG. 12A is a chart illustrating a payout policy associated with a referral scheme that an embodiment of the present invention may use. This illustration shows how a number of users are related to each other based on how the user was referred into the system. This relationship is graphically represented by a pyramid 1230. Each layer of the pyramid is assigned a label 1210, such as “Homesteader” and “1st Upline Layer”. The percentages listed in column 1220 show the percentage of revenue user A would receive for a revenue generating event created at that level in the pyramid. The tiered compensation structure may be maintained through the transaction server 307 and transaction database 308 to its homesteaders and stakeholders. For example, if user A generated revenue off of a SKU or page that user A owned, user A would receive 5% of that revenue. If user D5 generated revenue off of a SKU or page owned by D5, then user A would receive 1% of that revenue. Similarly, User A would receive 4% of the revenue generated by SKUs owned by users B1, B2, or B3. Of course, different embodiments may use different percentages. User A would receive these percentages of revenue generated by these users because User A is related to these users through a referral chain. User A referred users B1, B2, and B3 into the system, and those users, in turn, referred in the users listed below them in the pyramid 1230.

The percentages listed in 1220 would also apply in a similar fashion to other users represented in the pyramid based on the relationship between users. For example, assume that A refers B1, B1 refers C1, C1 refers D1, and D1 refers E1 in a linear referral chain. If D1 is a homesteader for an item and this item is traded through transaction server 307 resulting in a transaction fee of $20 and an advertisement revenue of $80, D1 will be entitled to 5% ($5), C1 4% ($4), B1 2% ($2), and A 1% ($1) of the gross homesteading receipts of $100.

FIG. 12B is a table illustrating a referral scheme which an embodiment of the present invention may use. FIG. 12B shows how revenue generated by homesteading activities of A, B2, D4, and E5 is shared between the users. FIG. 12B also shows how User C3 can earn referral revenues as a stakeholder even though it is not a homesteader.

Assume in another referral chain A refers B2, B2 refers C3, C3 refers D4, and D4 refers E5. Suppose A, B2, D4, and E5 are homesteaders, but not C3, and all their items are traded through transaction server 307 resulting in the gross homesteading receipts shown in FIG. 12B. A will earn $2.50 as a homesteader and $7 as a stakeholder in which A has a financial interest through A's downline referral chain. E5 will earn $12.00 as a homesteader but E5's upline referrers will be rewarded a total of $16.80 for having brought E5 into the networked community.

In addition to the income earned by each user in this referral chain for their homesteading activities, FIG. 12B shows the total percentage of each user's revenue that has been distributed to users. For example, $12.00 of the $10.00 of revenue generated by D4 has been distributed to users of community. This is equal to 12% of the $100.00, which means that 12% of the revenue is kept by the community created by D4.

Aside from the percentage of revenue a given user is entitled to receive based on the user's relationship to SKUs and other users, a payout policy may go through the following steps to implement one example payout policy:

1) Is the registered member a homesteader?

2) If yes, is there transaction and/or advertisement revenue associated with the homesteaded items. If not, no payout occurs.

3) If yes, has the homesteader provided the requisite information? If not, no payout occurs.

4) If yes, allocate a percentage of the gross homesteading receipts to him or her.

5) Does the homesteader have upline stakeholder(s)? If no, no further payout.

6) If yes, has the stakeholder provided the requisite information? If no, no payout and disqualify the immediate upline stakeholder from receiving a payout too. Move to the next upline stakeholder and ask if he or she has provided the requisite information.

7) If yes, allocate the appropriate percentage payout to the upline stakeholder and move up to the next level stakeholder and ask if he or she has provided the requisite information.

8) Lastly, verify if the referral structure has more than 3 levels of referral. If no, confirm payout. If yes, trigger a red flag for administrator to check payment process.

Alternative payout policies may look at additional factors when determining if a user is entitled to a percentage of revenue generated. For example, category experts may receive a percentage of revenue generated from any SKUs for which they are an expert.

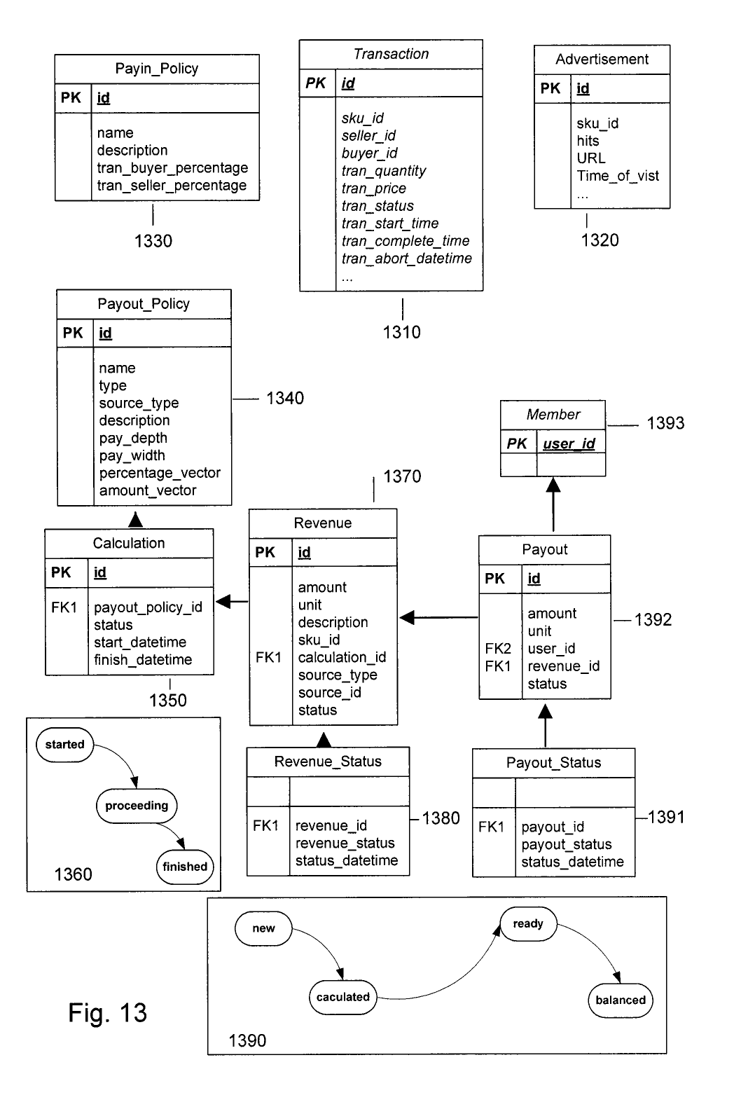

FIG. 13 is a simplified block diagram illustrating of a data model for revenue sharing and payout which an embodiment of the present invention may use. The Transaction table 1310 records all information about transaction including transaction id, transaction price, buyer id, seller id and status etc. The Advertisement table 1320 is used to record statistics data for user visiting advertisement published in transaction server 307. When any third-party company pays for it, this data is used to divide money to each SKU. The Payin_Policy table 1330 describes how transaction server 307 may charge the seller and buyer in each transaction. The Payout_Policy table 1340 describes how to divide single revenue into multiple payouts. ‘type’ means it's calculated on percentage base in ‘percentage_vector’ or absolute value in ‘amount_vector’. The pay_depth means the maximum number of sponsors a SKU owner need pay, and pay_width means that the maximum recruits that one sponsor can gather money from.

The Calculation table 1350 describes a process with information including payout policy used, status which is one of ‘started’, ‘proceeding’ or ‘finished’ and start/finish timestamp. These status are displayed by state diagram 1360.

The Revenue 1370 and Revenue_Status 1380 tables are used to record revenue information and status which is one of ‘new’ or ‘calculated’ as described above. The Payout 1392 and Payout_Status 1391 tables are used to record payout information and status which is one of ‘ready’ or ‘balanced’ as described above. These states are depicted in state diagram 1390.

Payouts can be linked to the member table 1393 that stores additional information about users.

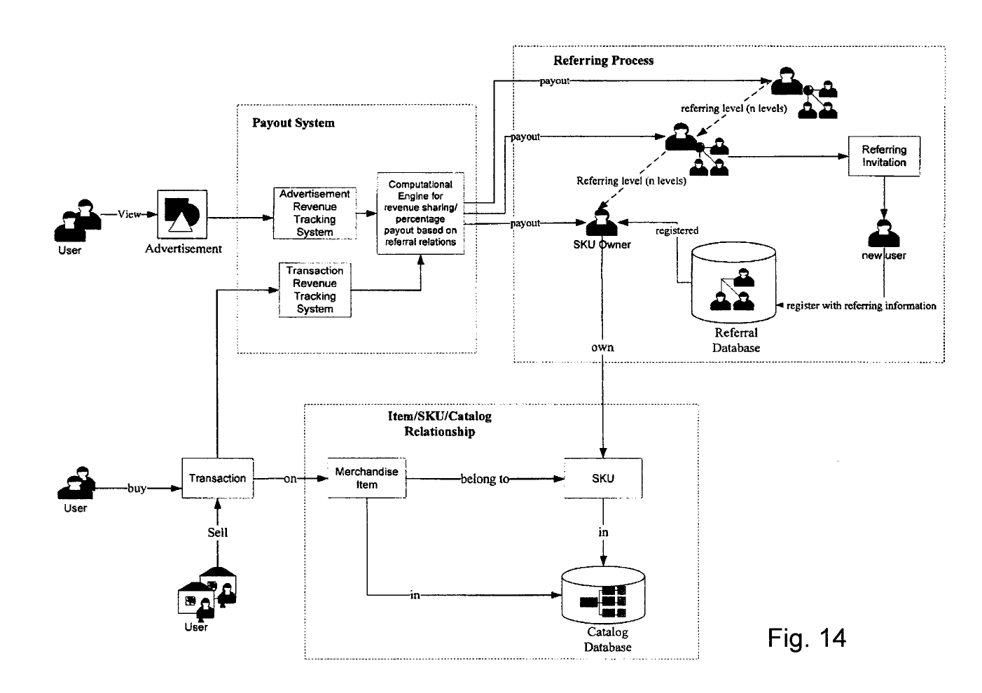

FIG. 14 is a diagram illustrating one embodiment of the present invention. In the illustration, many of the concepts, structures, and relationships disclosed are tied together. For example, revenue generated from advertisements is sent to a payout system, wherein the payout system then determines how some of that revenue is to be divided among various SKU owners. Similarly, revenue generated from transactions involving SKUs is also sent to the payout system for processing. SKU relationships are maintained in a catalog database. The catalog database in the diagram is analogous to item database 304.

Further embodiments can be envisioned to one of ordinary skill in the art after reading this disclosure. In other embodiments, combinations or sub-combinations of the above disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

APPENDIX A
SUPPORT OPERATIONS AND PROCESSES

```
Assume the id for ‘wigix root’ is 0, whose sponsor_id is −1.
Assume the maximum sponsor levels that a node can remember is 5, N = 5 in this case.
- Initialize/Reinitialize whole tree
    Initialize records whose sponsor_id is set with value, and set sponsor_id to root for
those sponsor id is null.
Pseudocode:
        update nodes set sponsor_id = 0 where sponsor_id = null
        update nodes set sponsors_hierarchy=null
        update nodes set sponsors_hierarchy=“/−1/−1/−1/−1/0/”, sponsor_id=−1 where
id=0
        arrsponsorsPath = new array( )
        arrsponsorsPath = {−1, −1, −1, −1, 0}
        G = new array( )
        G = {0}
        while G is not null
            S = execute “select * from nodes where sponsor_id in G”
            arrsponsorsPath[0] = arrsponsorsPath[1]
            arrsponsorsPath[1] = arrsponsorsPath[2]
            arrsponsorsPath[2] = arrsponsorsPath[3]
            arrsponsorsPath[3] = arrsponsorsPath[4]
            foreach n in S
                arrsponsorsPath[4] = n.id
                update node set
sponsors_hierarchy=‘/arrsponsorsPath[0]/.../arrsponsorsPath[4]/’, sponsor_id=−1
            end foreach
            G = S
        end while
    Cost: ~ count of nodes on the tree
- Add a single user
    Add a single user U as leaf
Pseudocode:
    P = execute “select * from nodes where id=U.sponsor_id”
    arrsponsorsPath = parse_array_from_string(P.sponsors_hierarchy)
        insert into node values (U.id, U.sponsor_id,
“arrsponsorsPath[1]/arrsponsorsPath[2]/arrsponsorsPath[3]/arrsponsorsPath[4]/U.id”)
    Cost: ~ 2 SQL
- Delete a single user U without delete recruits
    Delete a single user U without delete recruits, U’s recruits are give to U’s sponsor
Pseudocode:
        U = execute “select * from nodes where id=U.id”
        arrU = parse_array_from_string(U.sponsors_hierarchy)
        //1st level
        update node set
replace(sponsors_hierarchy,’/arrU[1]/.../arrU[3]/U.id/’,’/arrU[0]/.../arrU[3]/’),
sponsor_id=P.id where node.sponsors_hierarchy like ‘/arrU[1]/.../arrU[3]/U.id/%’
        //2nd level
        update node set
replace(sponsors_hierarchy,’/arrU[2]/arrU[3]/U.id/,’/arrU[1]/.../arrU[3]/’) where
node.sponsors_hierarchy like ‘/arrU[2]/.../arrU[3]/U.id/%’
        ......
        //repeat for those nodes whose node.sponsors_hierarchy like ‘/U.id/%’
        delete from node where id = U.id
    Cost: ~ N SQL
- Add a referral sub-tree to referral tree
    Add a subtree whose root is U to under node P
Pseudocode:
        Initialize/Reinitialize subtree U, or ignore this if subtree U is moved from
other branch
        Insert into nodes with all nodes of U
        Update node set node.sponsor_id=P.id where node.id=U.id
        arrU = parse_array_from_string(U.sponsors_hierarchy)
        arrP = parse_array_from_string(P.sponsors_hierarchy)
        update node set replace(sponsors_hierarchy,’/arrU[3]/U.id/’,’/arrP[4]/U.id/’)
where node.sponsors_hierarchy like ‘/arrU[3]/U.id/%’
        update node set
replace(sponsors_hierarchy,’/arrU[2]/arrU[3]/U.id/’,’/arrP[3]/arrP[4]/U.id/’) where
node.sponsors_hierarchy like ‘/arrU[2]/arrU[3]/U.id/%’
        ......
        //repeat till for those nodes whose node.sponsors_hierarchy like
‘/arrU[0]/../arrU[3]/U.id/’
    Cost: ~ N+1 SQL, 6 in this case
- Delete a single user and delete his recruits
    Delete a subtree whose root is U from whole tree
Pseudocode:
        arrU = parse_array_from_string(U.sponsors_hierarchy)
        delete from node where node.sponsors_hierarchy like ‘/arrU[3]/U.id/%’
        delete from node where node.sponsors_hierarchy like
‘/arrU[2]/arrU[3]/U.id/%’
        ......
        //repeat till for node.sponsors_hierarchy like ‘/arrU[0]/../arrU[3]/U.id/’
        For those nodes whose node.sponsors_hierarchy like ‘/U.id/%’, recusive call
“Delete a single user and delete his recruits”
    Cost: depending on shape of tree. For node which is distance less then N, N SQL; For
node which is distance less then 2N,
                N * [number of nodes distance N] SQL, ...
- Query/Count n(>=0) levels sponsors of a user
    Query/Count n(>=0) levels sponsors of a user U
Pseudocode:
        arrU = parse_array_from_string(U.sponsors_hierarchy)
        S = arrU
        count = arrU.size
        while arrU[0]!=0 and count < n
            X = execute ‘select * from node where id = arrU[0]’
            arrU = parse_array_from_string(X.sponsors_hierarchy)
            S += arrU
            count += arrU.size
        end while
        return S
    Cost: depending on depth n, [n/N] SQL
-Query/Count all levels sponsors of a user
    Query/Count all levels sponsors of a user U
Pseudocode:
        arrU = parse_array_from_string(U.sponsors_hierarchy)
        S = arrU
        while arrU[0]!=0
            X = execute ‘select * from node where id = arrU[0]’
            arrU = parse_array_from_string(X.sponsors_hierarchy)
            S += arrU
        end while
        return S
    Cost: depending on depth of U, [depth of U/N] SQL
- Query/Count n(>=0) levels recruits of a user
    Query/Count n(>=0) levels recruits of a user U
Pseudocode:
        arrU = parse_array_from_string(U.sponsors_hierarchy)
        //U
        select * from node where node.sponsors_hierarchy like
‘/arrU[0]/../arrU[3]/U.id/’
        //1st level
        select * from node where node.sponsors_hierarchy like
‘/arrU[1]/arrU[2]/../U.id/’
        ...
        //5th level
        For those nodes whose node.sponsors_hierarchy like ‘/U.id/%’, recusive call
“Query/Count n(>=0) levels recruits of a user”
    Cost: depending on shape of tree. For node which is distance less then N, N SQL; For
node which is distance less then 2N,
                N * [number of nodes distance N] SQL, ... till distance n.
- Query/Count all recruits of a user
    Query/Count all recruits of a user U
Pseudocode:
        arrU = parse_array_from_string(U.sponsors_hierarchy)
        //U
        select * from node where node.sponsors_hierarchy like
‘/arrU[0]/../arrU[3]/U.id/’
        //1st level
        select * from node where node.sponsors_hierarchy like
‘/arrU[1]/arrU[2]/../U.id/’
        ...
        //5th level
        For those nodes whose node.sponsors_hierarchy like ‘/U.id/%’, recusive call
“Query/Count n(>=0) levels recruits of a user”
    Cost: depending on shape of tree. For node which is distance less then N, N SQL; For
node which is distance less then 2N,
                N * [number of nodes distance N] SQL, ...
- Judge if two nodes are sponsor-recruit
    Judge if P is sponsor of U
Pseudocode:
        arrU = parse_array_from_string(U.sponsors_hierarchy)
        S = arrU
        while arrU[0]!=0 and P is not in arrU
            X = execute ‘select * from node where id = arrU[0]’
            arrU = parse_array_from_string(X.sponsors_hierarchy)
            S += arrU
        end while
        if (P is in arrU) return true
        return false
    Cost: depending on distance of P and U, [depth of U/N] or [distance/N] SQL
- Find sibling
    Find sibling of user U
Pseudocode:
        select * from node where node.sponsor_id = U.sponsor_id
    Cost: 1 SQL
-Get distance of two nodes
    Get distance of two nodes U and P
Pseudocode:
        arrU = parse_array_from_string(U.sponsors_hierarchy)
        S = arrU
        while arrU[0]!=0 and P is not in arrU
            X = execute ‘select * from node where id = arrU[0]’
            arrU = parse_array_from_string(X.sponsors_hierarchy)
            S += arrU
        end while
        if (P is not in arrU) reverse U and P and do above again.
    Cost: depending on distance of P and U, [depth of U/N] + [distance/N] SQL or
[distance/N] SQL.
```

1. An apparatus for tracking user contributions and distributing revenue associated with the user contributions, the apparatus comprising:
an item database,
an item server coupled to the item database, the item server capable of reading and modifying the item database;
a transaction database; and
a transaction server coupled to the transaction database, the transaction server capable of reading and modifying the transaction database;
wherein the item database comprises a table of associations;
wherein the table of associations associates an owner with an item record;
wherein the owner is a user that contributed to the item database by requesting the item record to be added to the item database or by perfecting an existing item record, wherein the transaction database comprises a table of transactions;
wherein the table of transactions associates revenue with item records.

2. The apparatus of claim 1 wherein each item record can be transferred from the owner to a new owner, wherein the new owner is another user.

3. The apparatus of claim 1 wherein each item record further comprises a list of attributes associated with an item.

4. The apparatus of claim 3 wherein the list of attributes associated with an item is used to compare a new item record to be added to the item database with the item records already stored in the item database to determine whether the new item record is sufficiently distinct from the item records already stored in the item database.

5. The apparatus of claim 1 wherein the item database further comprises a category table, wherein the category table comprises a table associating a category with a set of item records.

6. The apparatus of claim 5 wherein the category table associates a category with a category expert, wherein the category expert is a user capable maintaining the set of item records associated with the category.

7. The apparatus of claim 1 wherein the item database further comprises a referral table, wherein the referral table associates one or more referred users that have been referred by the user.

8. The apparatus of claim 1 wherein the revenue associated with item records includes advertising revenue and transactional revenue.

9. The apparatus of claim 1 further comprising a revenue sharing engine wherein the revenue sharing engine shares the revenue associated with item records with the owners of the item records.

10. The apparatus of claim 9 wherein the revenue sharing engine shares the revenue associated with item records with up to N users in a referral chain associated with the owner of the item records, wherein N represents the number of levels up the referral chain the revenue is shared.

11. The apparatus of claim 10 wherein the amount of revenue a user in the referral chain receives is a function of the number of levels up the referral chain the user is from the owner of the item records.

12. A method for distributing revenue associated with user contributions to a community of users, the method comprising:
registering a user with a community of users;
associating the user with a referral chain if the user was referred to the community of users by a referral user, wherein the referral chain associates the user with a chain of users who have each referred each other to the community of users;
assigning one or more pages to the user;
associating revenue generated from the community of users with one or more pages; and
sharing at least a portion of the revenue associated with one or more pages with the user assigned to the page and with up to N additional users in the referral chain of the user.

13. The method of claim 12 wherein a page is assigned to the user when the user creates a new page in the community of users.

14. The method of claim 12 wherein a page is assigned to the user when the user perfects an existing page in the community of users.

15. The method of claim 12 wherein at least a portion of the revenue associated with one or more pages is generated from transactions involving the page between users in the community of users.

16. The method of claim 12 wherein at least a portion of the revenue associated with one or more pages is generated from advertising revenue associated with the page.

17. The method of claim 12 wherein the revenue shared with the up to N additional users in the referral chain of the user is shared as a function of the distance each of the N additional users is from the user in the referral chain.

18. The method of claim 12 further comprising associating the user with one or more categories so that the user becomes a category expert for the one or more categories, wherein each category is associated with a set of pages.

19. The method of claim 18 further comprising sharing at least a portion of the revenue associated with each page in a category with the category expert.

20. A computer readable medium comprising code for performing the method of claim 12.
